(19) United States
(12) Patent Application Publication
(10) Pub. No.: US 2026/0187603 A1
(43) Pub. Date: Jul. 2, 2026

(54) GENERATING ORCHESTRATION RULES IN EVENT MANAGEMENT

(71) Applicant: PagerDuty, Inc., San Francisco, CA (US)

(72) Inventors: Irena Grabovitch - Zuyev, Quispamsis (CA); Francis Edmund Emery, Toronto (CA); Jung Soh, Calgary (CA); Pankhudi Seth, Toronto (CA)

(21) Appl. No.: 19/005,245

(22) Filed: Dec. 30, 2024

(51) Int. Cl. G06Q 10/20

(52) U.S. Cl. CPC G06Q 10/20

(57) ABSTRACT

Events in a historical event dataset to which an action was applied are selected. The events are clustered into clusters based on shared event characteristics. A proposed orchestration rule associated with the action is generated. The proposed orchestration rule specifies conditions for applying the action to events that match the shared event characteristics of events within one of the clusters. The proposed orchestration rule is displayed in association with an incoming event that matches the shared event characteristics. An input indicating whether to automatically apply the proposed orchestration rule with future events matching the shared event characteristics is received.

### TECHNICAL FIELD

This disclosure relates generally to computer operations and more particularly, but not exclusively, to generating orchestration rules in event management.

### SUMMARY

A first aspect of the disclosed implementations is a method that includes selecting events in a historical event dataset to which an action was applied. The method also includes clustering the events into clusters based on shared event characteristics. The method also includes generating a proposed orchestration rule associated with the action, where the proposed orchestration rule specifies conditions for applying the action to events that match the shared event characteristics of events within one of the clusters. The method also includes displaying the proposed orchestration rule in association with an incoming event that matches the shared event characteristics. The method also includes receiving an input indicating whether to automatically apply the proposed orchestration rule with future events matching the shared event characteristics. A second aspect of the disclosed implementations is a system that includes one or more memories and one or more processors. The one or more processors are configured to execute instructions stored in the one or more memories to select events in a historical event dataset to which an action was applied; cluster the events into clusters based on shared event characteristics; generate a proposed orchestration rule associated with the action, where the proposed orchestration rule specifies conditions for applying the action to events that match the shared event characteristics of events within one of the clusters; and display the proposed orchestration rule in association with an incoming event that matches the shared event characteristics; and receive an input indicating whether to automatically apply the proposed orchestration rule with future events matching the shared event characteristics.

A third aspect of the disclosed implementations is one or more non-transitory computer readable media storing instructions operable to cause one or more processors to perform operations. The operations include selecting events in a historical event dataset to which an action was applied; clustering the events into clusters based on shared event characteristics; generating a proposed orchestration rule associated with the action, where the proposed orchestration rule specifies conditions for applying the action to events that match the shared event characteristics of events within one of the clusters; displaying the proposed orchestration rule in association with an incoming event that matches the shared event characteristics; and receiving an input indicating whether to automatically apply the proposed orchestration rule with future events matching the shared event characteristics.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of a system for generating incident status reports.

FIG. 5 is a block diagram of a system for generating proposed orchestration rules based on historical event data.

FIG. 6 illustrates user interfaces of an orchestration rule editor.

FIG. 7 is a block diagram of example functionality of an orchestration rule generation software.

FIGS. 8A-8C illustrate a technique for generating proposed orchestration rules.

FIG. 9 illustrates a two-dimensional visualization of a clustering output generated by a clustering model.

FIG. 10 is an example of a user interface for displaying proposed orchestration rules.

FIG. 11 illustrates an example technique for generating and applying orchestration rules based on historical event data.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to an information technology (IT) service of an organization. An event can be or describe a fact at a moment in time that may consist of a single or a group of correlated conditions that have been monitored and classified into an actionable state. As such, a monitoring tool of an organization may detect a condition in the IT environment (e.g. such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 503 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires the performance (by a human or an automated task) of an action. Thus, the alert may embody or include the action to be performed.

An incident associated with an alert may or may not be used to notify the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

An EMB may handle (e.g., process) events using what is referred to herein as event orchestration. Event orchestration refers to a set of configured rules (e.g., workflows) that automate the processing of incoming events and/or subsequent objects (e.g., alerts, incidents, or notifications) derived from them. For example, rules may be configured to automatically trigger responses based on specific event attributes, such as title, origin, class, type, or other relevant data. As mentioned above, an event can include any detected change or status within an organization's IT environment, which may require action. Orchestration rules specify actions to be performed when certain criteria are met, such as escalating priority, suppressing non-critical events, or notifying designated responders.

Orchestrations are designed (e.g., configured) by authorized users to reduce manual intervention for predictable, recurring events. However, even with orchestration rules configured, there are many instances that still require manual actions. This can occur when events do not match existing rules, when the rules lack the specificity needed to address certain critical or nuanced situations, or when rules become outdated. For example, a rule intended to suppress non-critical events associated with an IT component might become ineffective or outdated if that IT component becomes essential due to infrastructure changes or shifts in business priorities.

As such, although event orchestration provides a foundational framework for managing event flows, it is often limited by its static and manual setup, which cannot keep pace with dynamically changing environments. Static orchestration rules may fail to address evolving operational needs. Additionally, static rules are often based on assumptions about predictable conditions, which may not reflect the complexity of real-time data patterns across an organization. Furthermore, certain types of events may not be accounted for in the rule configuration at all. For example, if new event types or unexpected patterns arise that were not anticipated when the orchestration rules were initially set, these events will bypass existing rules, leading to missed incidents or delayed responses. Such gaps in orchestration leave organizations vulnerable to unhandled or improperly prioritized events, increasing the need for manual intervention.

When responders must frequently intervene to manually apply or override actions for events that do not fit predefined criteria, the efficiency of automated event handling is undermined. This reliance on manual intervention adds operational overhead, increases response time, and raises the risk of human error, especially as orchestration rules struggle to scale within complex, large-scale enterprise environments that require flexibility and adaptability.

Implementations according to this disclosure solve problems such as these by providing an adaptive, data-driven event management system. The system leverages historical event data and machine learning-based clustering techniques to automatically generate, optimize, and recommend orchestration rules. By analyzing past event patterns, such as the frequency and types of actions (e.g., manual actions) applied to events (e.g., priority escalations, suppressions, or reassignment of events to different responders), and by examining event characteristics (e.g., event source, severity, category, etc.), the system can group similar events and identify recurring actions taken by responders for particular clusters of events, including frequently applied actions. Such analysis of historical responder actions enables the system to recognize patterns where certain event types consistently require specific responses, allowing it to recommend or automatically adjust orchestration rules to handle similar future events without manual intervention.

The system initiates a rule identification and recommendation process by first selecting a specific action frequently applied by responders (e.g., priority escalation or suppression). Events in the historical data where this action was manually applied are then identified. These events are subsequently grouped into clusters based on shared characteristics, such as event type, source, severity, or any other attributes using clustering techniques to reveal patterns in responder actions. Based on the attributes within each cluster, the system generates and recommends orchestration rules that can automatically apply similar actions to future events with matching characteristics.

A clustering technique described herein, which relates to the clustering of historical events where actions (e.g., systemizable actions) were applied to identify and propose orchestration rules, provides several technical benefits, making it adaptable to different event characteristics and systemizable actions. A systemizable action refers to an action that is manually applied to events by responders and that may exhibit patterns in its application suitable for conversion into systematic, rule-based execution. Said another way, a systemizable action refers to an action that can potentially be formalized, encoded, or configured into an orchestration rule or workflow for automated application. Given a systemizable action, a proposed orchestration rule is generated therefor. The proposed orchestration rule may then be presented to a user for review and, if accepted, incorporated into an orchestration system for automated application to future events. The systemizable action can be or include more than one action. That is, the systemizable action can be a series (e.g., a set) of actions.

Different customers (i.e., organizations) may have events with varying numbers and types of fields (e.g., a first customer's events related to database monitoring may include fields that are significantly different from the events related to database monitoring of a second customer; and the first customer's events related to database monitoring may include fields that are significantly different from events related to application monitoring). The clustering technique automatically adapts to such variations in the input data structures through preprocessing, dimensionality reduction, and optimal hyperparameter search steps.

Furthermore, the clustering technique self-adjusts its algorithmic configuration based on dataset characteristics. To illustrate, and without limitations, for smaller datasets (e.g., less than 300,000 events), the clustering technique configures itself with fewer neighbors (e.g., 100) and configures itself to explore smaller minimum cluster sizes (e.g., 50-200 events), while for larger datasets, these parameters are automatically adjusted to larger values (e.g., 200 neighbors and cluster sizes of 250-650 events) to maintain clustering accuracy. This self-adaptation extends to different types of systemizable actions (e.g., suppression, escalation, reassignment) as the clustering technique identifies relevant feature combinations and clustering patterns specific to each action type through its two-step dimensionality reduction process. Thus, the clustering technique provides a generic approach that can automatically adapt to different event schemas, dataset sizes, and action types while maintaining accurate identification of features for proposing orchestration rules.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, received, etc.) by an event management bus. An event management bus (which can also be referred to as an event ingestion and processing system) may be configured to monitor various types of events depending on the needs of an industry and/or technology area. For example, IT services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof. An event (e.g., an event object) may be directly created (such as by a human) in the EMB via user interfaces of the EMB.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder,” as used herein, can refer to a person or entity, represented or identified by persons, who may be responsible for responding to an event associated with a monitored application or service. A responder is responsible for responding to one or more notification events. For example, responders may be members of an IT team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or systems for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

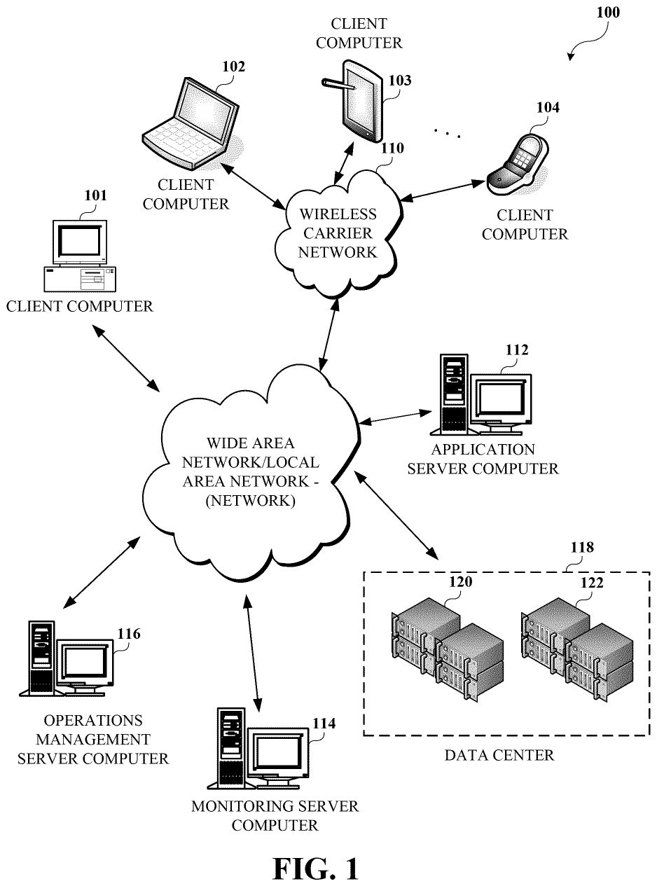

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2 G), 3rd (3 G), 4th (4 G), 5th (5 G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanisms and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

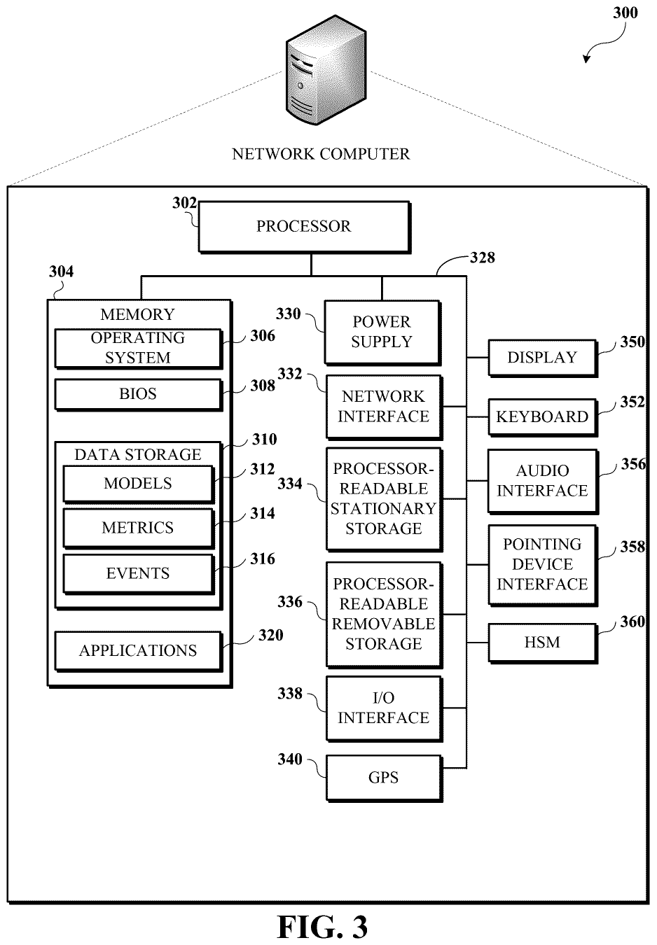

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

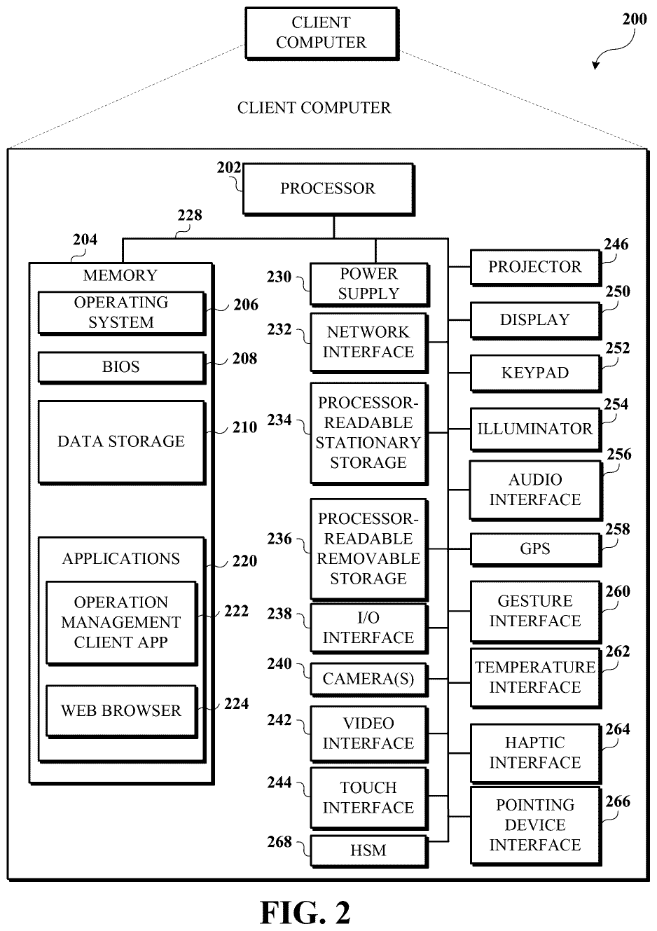

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measure or maintain an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like.

Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory 204 may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Inc.'s IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for generating smart incident status updates using generative artificial intelligence. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, at least some of the applications 320 may be operative in a cloud-based computing environment. In at least one of the various embodiments, these applications, and others, which include the management platform may be executing within virtual machines or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to at least some of the applications 320 may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces as well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 108 or the network 111.

Also, in at least one of the various embodiments, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

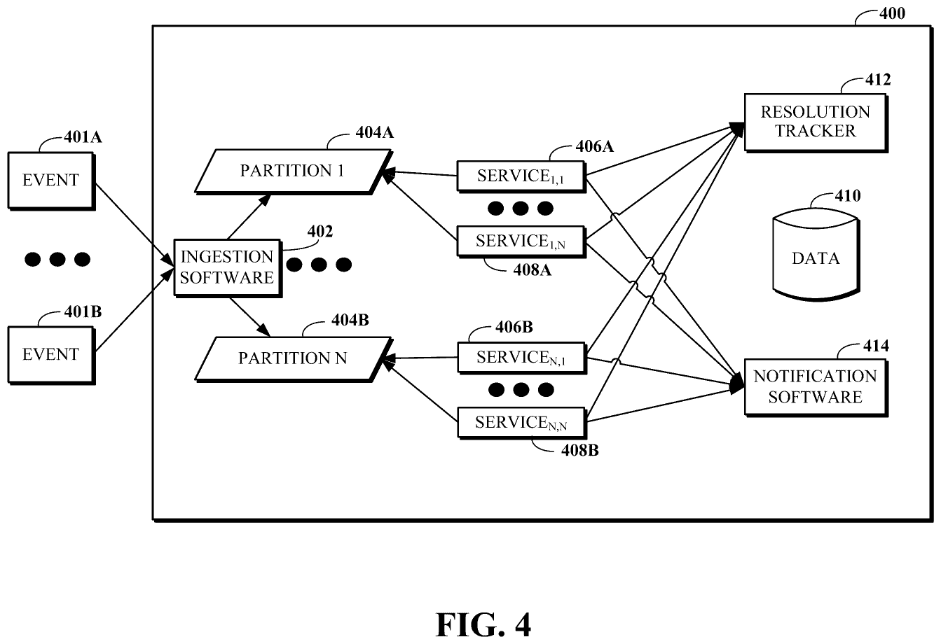

FIG. 4 illustrates a logical architecture of a system 400 for generating incident status reports. In at least one of the various embodiments, a system for automatically generating smart incident status updates may include various components. In this example, the system 400 includes an ingestion software 402, one or more partitions 404A-404B, one or more services 406A-406B and 408A-408B, a data store 410, a resolution tracker 412, and a notification software 414.

One or more systems, such as monitoring systems, of one or more organizations may be configured to transmit events to the system 400 for processing. The system 400 may provide several services. A service may, for example, process an event and determine whether a downstream object (e.g., an incident) is to be triggered. As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by the same service would include two different routing keys. A routing key may be unique to the service that is to receive and process an event. As such, two events associated with two different routing keys and received from the same managed organization for processing may be directed to (e.g., processed by) different services.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the system 400 so that the system 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion software 402 may be arranged to normalize incoming events into a unified common event format.

Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406B and 408A-408B may perform different logic as appropriate for the events processed by the service.

An (e.g., each) event may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated metadata, such as, a title (or subject), a source, a creation time stamp, a status indicator, a region, more information, fewer information, other information, or a combination thereof, that may be tracked. In an example, the event data may be received as structured data, which may be formatted using JavaScript Object Notation (JSON), XML, or some other structured format. The metadata associated with an event is not limited in any way. The metadata included in or associated with an event can be whatever the sender of the event deems required.

In at least one of the various embodiments, a data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the system 400 received, such as from the integration, an event indicating that a previous event, which triggered the alert, is resolved. The integration may be a monitoring system.

The data store 410 can be used to store, inter alia, incident data. An incident may be represented as an object in the data store 410. For brevity, an incident object is simply referred to as an incident. In an example, the incident data may be notes (textual or otherwise) entered in association with the incident by responders. The incident data may include an association to one or more responders, such as those assigned to the incident. The set of notes associated with an incident may be referred to as an incident timeline. In an example, at least some of the notes of the incident timeline may be programmatically obtained, by one or more components of the system 400, from other systems.

In at least one of the various embodiments, the resolution tracker 412 may be arranged to monitor the details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may be associated with one resolution tracker. Other configurations or mappings between partitions, services, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification software 414 may generate one or more notification messages and determine a particular message provider to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification software 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured.

In at least one of the various embodiments, the system 400 may include various user-interfaces or configuration information (not shown) that enable organizations to establish how events should be resolved. Accordingly, an organization may define rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if an object matches the template, then the tasks of the runbook can be performed (e.g., executed, orchestrated, etc.) according to the order, rules, and/or workflow specified in the runbook. In another example, the runbook can be associated with a type. As such, if an object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding objects and/or groups of objects. For example, a responder can use one of the user interfaces to obtain information regarding incidents assigned to or acknowledged by the responder. A user interface can be used to obtain information about an incident including the events (i.e., the group of events) associated with the incident. In an example, the responder can use the user interface to obtain information from the system 400 regarding the reason(s) a particular event was added to the group of events.

At least one of the services 406A-406B and 408A-408B may be configured to trigger alerts. A service can also trigger an incident from an alert, which in turn can cause notifications to be transmitted to one or more responders.

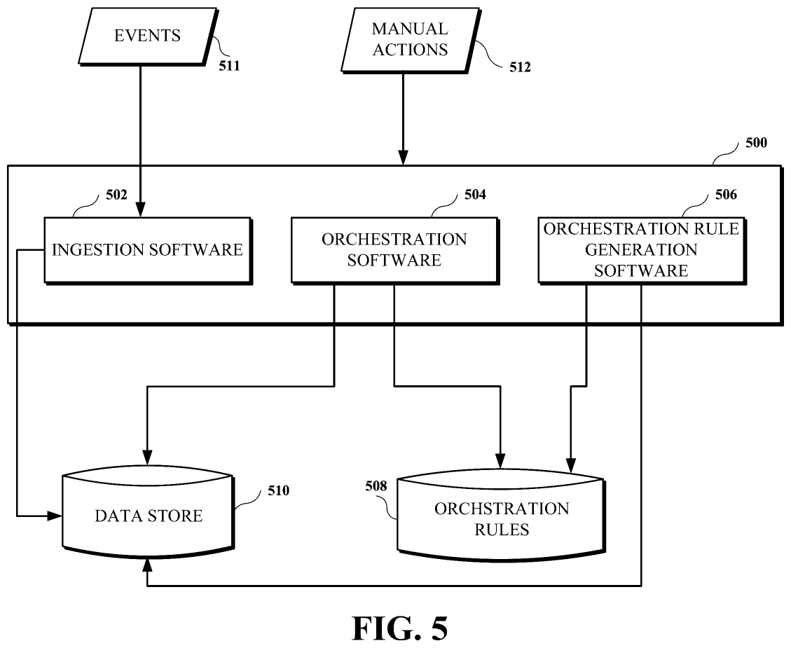

FIG. 5 is a block diagram of a system 500 for generating proposed orchestration rules based on historical event data. The system 500 includes ingestion software 502, orchestration software 504, and orchestration rule generation software 506. The system 500 can be or be included in the system 400 of FIG. 4. As such, the ingestion software 502 can correspond to the ingestion software 402 of FIG. 4. The orchestration software 504 is used to associate orchestration rules, which may be stored in orchestration rules 508, with services, such as those described in FIG. 4, or with the ingestion software 502. While not specifically shown in FIG. 4, the system 400 can include orchestration software, similar to the orchestration software 504. The orchestration rules 508 may be stored in a data store, such as the data store 410 of FIG. 4.

As described with respect to FIG. 4, incoming events 511 are ingested by the ingestion software 502. The ingestion software 502 may store the incoming events in a data store 510. Each incoming event includes characteristics (e.g., attributes and values) usable by the orchestration software 504 to determine applicable orchestration rules.

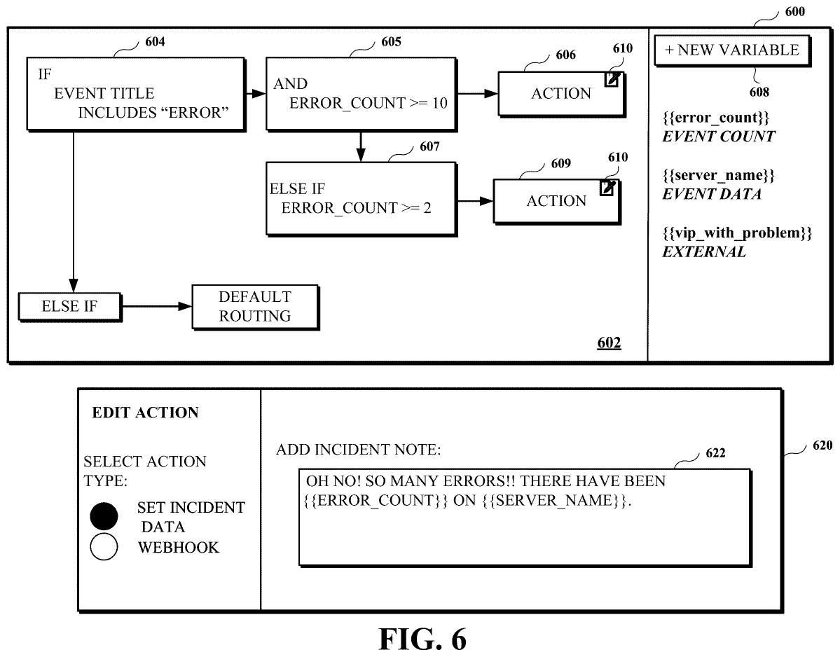

The orchestration rules 508 can be used by administrators or privileged users, such as described with respect to FIG. 6, to define actions that automate the processing and routing of incoming events. Orchestration refers to configuring automated rules (e.g., processes) and conditions to optimize event handling. Examples of orchestration actions include setting incident severity, annotating events, or enriching event payloads with contextual data. Global orchestration rules apply to all incoming events regardless of the destination service, while service-specific orchestration rules are limited to particular services.

One type of global orchestration rule, referred to as router rules, can be used to route events to specific services. For example, based on event attributes, a global orchestration rule might route database-related events to one service and front-end issues to another. These rules ensure efficient routing and processing of events across multiple service destinations.

When the orchestration software 504 is not configured with rules to handle certain events or when existing rules become outdated, manual actions 512 may be applied to those events. To illustrate, and without limitations, responders may manually modify event severity, reassign events, or add custom annotations via user interfaces provided by the system 500. Manual intervention, however, can prolong resolution times and reduce efficiency, particularly in high-volume environments.

The data store 510 records data indicative of actions applied to events. The actions may have been applied manually by a responder, by an orchestration rule, or via some other mechanism. That is, it will be possible to identify those events to which actions (e.g., manual actions) were applied. Non-limiting examples of manual actions include escalating event priority, adding custom notes, or assigning events to specific teams. This data serves as a historical record that can be analyzed to identify patterns and inform orchestration rule generation.

The orchestration rule generation software 506 identifies an action applied to events and generates proposed orchestration rules based on historical data to which the action (e.g., manual action) was applied. The orchestration rule generation software 506 can automatically detect the action or accept an input indicating the manual action from a privileged user. The orchestration rule generation software 506 retrieves historical event data from the data store 510 to identify patterns or characteristics that triggered the manual intervention. Based on this data, the orchestration rule generation software 506 creates one or more proposed orchestration rules that replicate the actions for future events with similar characteristics. For example, if events with specific characteristics (e.g., source=AWS and region=US) consistently require escalation (e.g., set priority=HIGHEST), the orchestration rule generation software 506 may propose an orchestration rule to automatically escalate such events (e.g., events matching the characteristics source=AWS and region=US). Privileged users can review and accept the proposed rules, which are then applied to incoming events to reduce reliance on manual intervention and improve response times.

FIG. 6 illustrates user interfaces 600 and 620 of an orchestration rule editor. The user interfaces 600 and 620 can be provided (e.g., generated, displayed, output, etc.) by orchestration software, such as the orchestration software 504 of FIG. 5. As can be appreciated, the orchestration rule editor may include many controls and features that enable a user to compose an orchestration rule on a canvas 602. However, for brevity, such controls and features are omitted from FIG. 6. The orchestration rule may be associated with ingestion software or a service, as described with respect to FIG. 5. The orchestration rule is evaluated (e.g., instantiated) for events based on a configuration (e.g., conditions) of the orchestration rule.

As shown in the user interface 600, the canvas 602 includes a graphical depiction of an orchestration rule. The orchestration rule includes a condition 604 that indicates that if the title of an event for which the orchestration rule is evaluated includes the word “error,” and (as shown in a condition 605) an error_count variable currently has a value that is greater than or equal to 10 (e.g., at least 10 events have been received meeting the configuration of the error count variable), then an action 606 is to be performed (e.g., executed) by the orchestration software. A condition 607 indicates that an action 609 is to be performed when the event title includes the word “error” and two or more events but less than 10 events that meet the configuration of the error count variable are received. It is to be noted, though, that the disclosure herein is not limited to or by any particular orchestration rule conditions or actions. A control 608 can be used to associate variables with the orchestration rule. The action 606 can be configured via an edit control 610. While not shown in FIG. 6, the orchestration software also presents user interfaces enabling configuration of the variables error count and server name via the control 608.

When the control 610 is invoked (e.g., clicked), the orchestration software displays the user interface 620 for configuring the action 606 (or the action 609, as the case may be) of the user interface 600. The user interface 620 illustrates that the action 606, when performed by the orchestration software adds a note to the event currently being processed based on a note configuration 622 where the note includes values (e.g., interpolations) of the variables named error count and server name. The double braces surrounding the cached variable names in the note configuration 622 direct the orchestration software to replace the placeholders {{error_count}} and {{server name}} with actual values of these cached variables.

The variable server name may be set from the field of the event named “component” based on the regular expression “(?<=SERVER:\s)\w+,” which uses a positive lookbehind (?<=SERVER:\s) to find the position right after “SERVER:” and a whitespace character and the \w+ then matches one or more word characters (like letters and numbers) that appear immediately after this position. As such, in the string “SERVER: KUBER1 crash”, it will match and return “KUBER1,” which may be a server identifier. For brevity, the update conditions illustrated in user interface 650 as the same as those used in FIG. 6B.

The variable error count may be configured as a counter for tracking incoming events with the word “error” in their titles. Thus, the orchestration rule of FIG. 6 is such that in response to receiving 10 (i.e., error_count=10) events within a certain time frame (e.g., 1 minute), an incident with the note indicated in the note configuration 622 is transmitted to a responder.

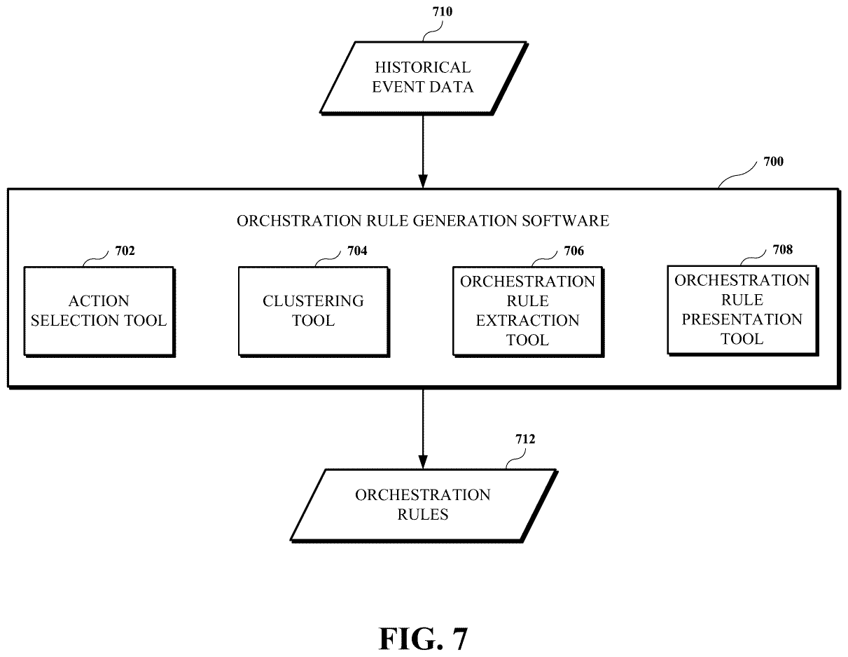

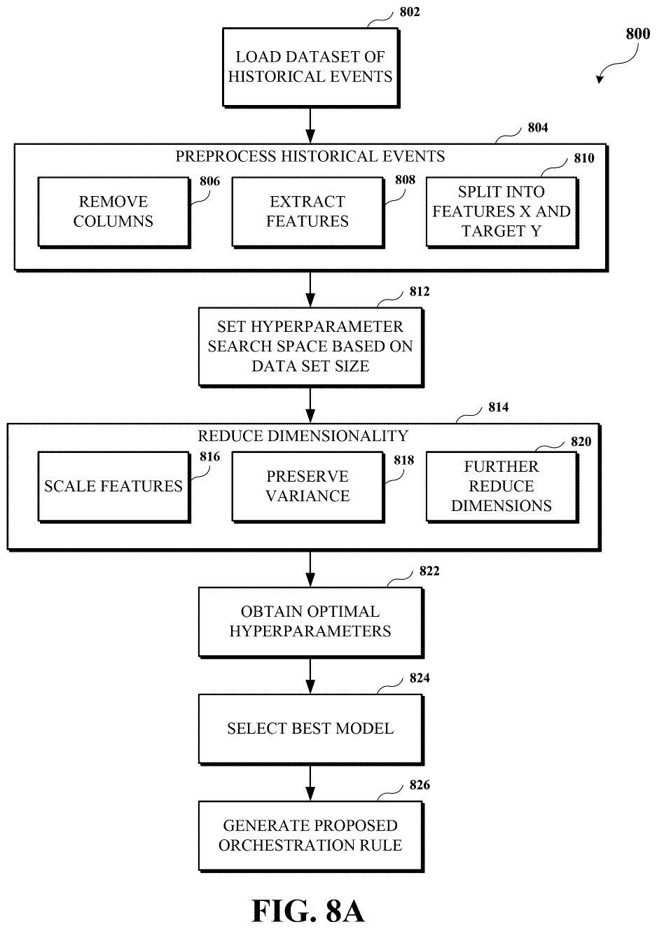

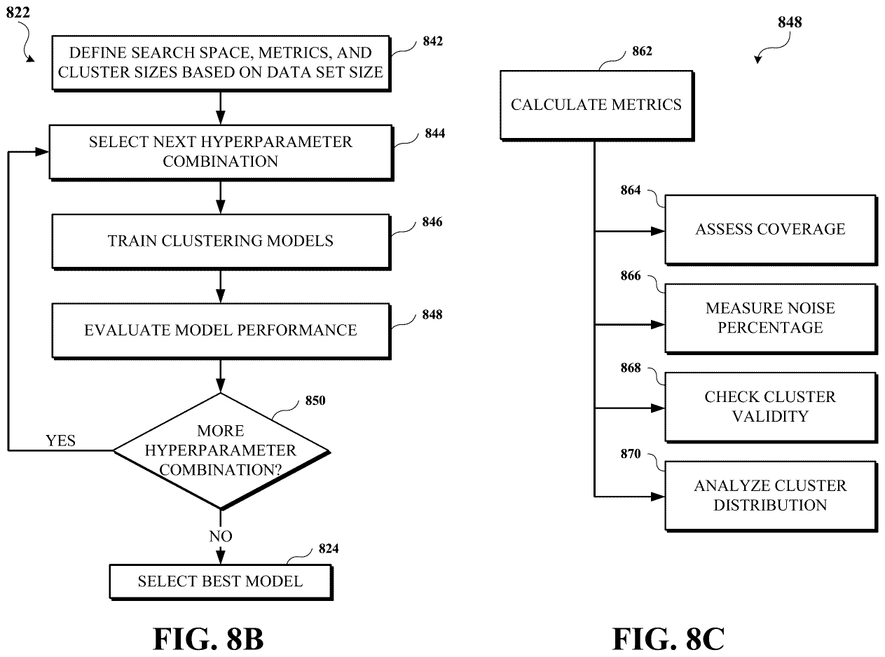

FIG. 7 is a block diagram of example functionality of an orchestration rule generation software 700. The orchestration rule generation software 700 can be the orchestration rule generation software 506 of FIG. 5. The orchestration rule generation software 700 includes tools, such as programs, subprograms, functions, routines, subroutines, operations, executable instructions, and/or the like for, inter alia and as further described, generating proposed orchestration rules based on historical data. The operations of the orchestration rule generation software 700 for generating proposed orchestration rules is described with respect to FIGS. 8A-8C.

At least some of the tools of the orchestration rule generation software 700 can be implemented as respective software programs that may be executed by one or more computing devices, such as the network computer 300 of FIG. 3. A software program can include machine-readable instructions that may be stored in one or more memories such as one or more of the memory 304, and that, when executed by one or more processors, such as the processor 302 of FIG. 3, may cause the computing device to perform the instructions of the software program.

As shown, the orchestration rule generation software 700 includes an action selection tool 702, a clustering tool 704, an orchestration rule extraction tool 706, and an orchestration rule presentation tool 708. In some implementations, the orchestration rule generation software 700 can include more or fewer tools. In some implementations, some of the tools may be combined, some of the tools may be split into more tools, or a combination thereof.

The action selection tool 702 identifies a specific action (i.e., a systemizable action) frequently applied by responders to events. The action may be a manual action. Non-limiting examples of manual actions include escalating or deescalating priority (e.g., modifying a priority field of an event), suppressing non-critical events (e.g., setting a flag on an event that causes the system 400 to not generate an alert and/or an incident therefrom), reassigning events to different responders, or adding annotations to event payloads. The action selection tool 702 may analyze historical event data 708 stored in a data store (e.g., the data store 510 of FIG. 5) to identify systemizable actions and uses this analysis to generate one or more proposed orchestration rules for at least some of the systemizable actions. In an example, the action selection tool 702 may present a list of actions (e.g., manual actions) in a user interface and receive input from a privileged user indicating a selection of a systemizable action, for which the orchestration rule generation software 700 is to generate proposed orchestration rules.

The clustering tool 704 first identifies historical events in the historical event data 708 to which the identified action (e.g., the systemizable action) was applied. The clustering tool 704 then groups the historical events into clusters based on their characteristics (e.g., attributes and attribute values). The clustering tool 704 employs machine learning algorithms, such as k-means clustering, hierarchical clustering, or density-based spatial clustering, to organize events into meaningful clusters. These clusters reveal patterns in responder behavior and event characteristics, which inform the generation of proposed orchestration rules.

The orchestration rule extraction tool 706 generates proposed orchestration rules based on the clusters and identified patterns. For each cluster that meets predefined metrics, the orchestration rule extraction tool 706 extracts (e.g., derives) attributes and values (e.g., characteristics) that characterize the cluster. Based on these characteristics, the orchestration rule extraction tool 706 defines conditions and actions for orchestration rules. For example, if a cluster includes events with the attribute “source=database” and “severity=high” that are frequently escalated, the orchestration rule extraction tool 706 may generate a proposed orchestration rule that, if accepted, automatically escalates such events.

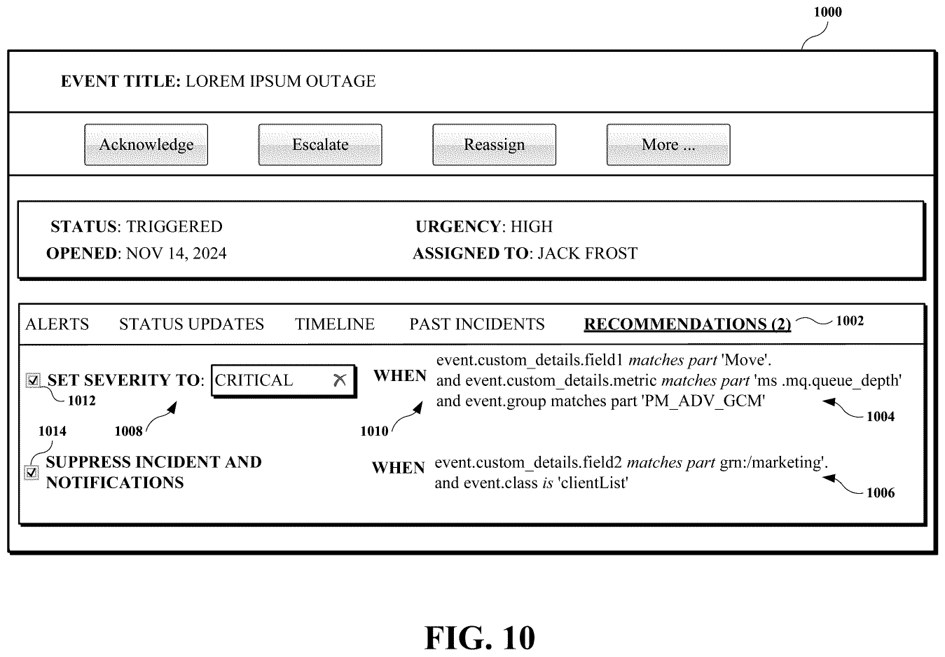

The orchestration rule presentation tool 708 provides a user interface for displaying proposed orchestration rules to administrators or privileged users for review and approval (e.g., incorporation into and use by the orchestration rules 508 of FIG. 5). The orchestration rule presentation tool 708 may present one or more of detailed explanations of each proposed orchestration rule, including the conditions, actions, and historical patterns that informed its generation. Users can modify, accept, or reject proposed rules through the user interface. Once approved, the orchestration rules are stored and applied to future events to automate the corresponding actions. An example of the user interface is described with respect to FIG. 10.

The orchestration rule presentation tool 708 may also manage conflicts between orchestration rules. When a proposed orchestration rule is accepted for incorporation, the orchestration rule presentation tool 708 identifies any existing orchestration rules that may conflict with the newly accepted rule. Two orchestration rules are considered conflicting when they have identical conditions but specify different actions. For example, if an existing rule specifies that events with conditions “source=database” AND “severity=high” should have their priority escalated, it would conflict with a newly accepted rule specifying that events with the same exact conditions “source=database” AND “severity=high” should be suppressed.

Upon identifying such conflicts, the orchestration rule presentation tool 708 may either present the conflicting rules to the privileged user through the user interface for manual resolution (e.g., deletion of conflicting rules) or, based on configuration settings, automatically delete the conflicting rules to ensure consistent event processing.

FIGS. 8A-8C illustrate a technique 800 for generating proposed orchestration rules. The technique 800 can be implemented by the orchestration rule generation software 700 of FIG. 7. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof.

To aid in understanding, the technique 800 is mostly described with respect to the systemizable action of suppressing events and employs several machine learning algorithms for clustering and dimensionality reduction. While the implementation shown uses specific algorithms, other algorithms or approaches (e.g., clustering algorithms) could be used. The primary algorithms described herein are: Principal Component Analysis (PCA), Uniform Manifold Approximation and Projection (UMAP), Hierarchical Density-Based Spatial Clustering of Applications with Noise (HDBSCAN), and Tree-structured Parzen Estimators (TPE).

PCA is a dimensionality reduction technique that transforms high-dimensional data into a lower-dimensional space by identifying the directions of greatest variance in the data. PCA aims to preserve as much of the important information (variance) as possible while reducing the number of features. For example, the technique 800 may be configured to keep enough principal components to explain 90% of the variance in the data set. UMAP is another dimensionality reduction technique that can be used to further reduce the output of PCA. UMAP focuses on preserving the topological structure of a data set. That is, UMAP attempts to maintain the relationships and neighborhoods between data points in the lower-dimensional space. For example, UMAP might be configured to reduce the data to 10 dimensions while ensuring that points that were close together in the original high-dimensional space remain close in the reduced space.

HDBSCAN is a clustering algorithm that groups similar events together based on density. HDBSCAN can identify clusters of varying densities and shapes, and marks outliers as noise. As further described herein, HDBSCAN can be configured with various distance metrics (e.g., Chebyshev, Euclidean, or Manhattan) and adjustable minimum cluster sizes. TPE is an optimization algorithm used to find the best hyperparameters for HDBSCAN.

The technique 800 uses dimensionality reduction for several critical purposes in the process of generating proposed orchestration rules from historical event data. Dimensionality reduction can reduce computational complexity. To illustrate, a data set that is to be clustered may contain N (e.g., N=500) event attributes and values (e.g., “features,” in clustering parlance), and processing such high-dimensional data is computationally expensive. Via dimensionality reduction, the N features may be first reduced to M (M<<N, e.g., M=40) dimensions via PCA and then to 10 dimensions via UMAP, making the clustering process more tractable and efficient.

Noise reduction is another key purpose of dimensionality reduction. To illustrate, not all of the N (e.g., 500) features are equally informative for identifying patterns in event suppression decisions. As such, configuring PCA's preservation to, for example, 90% variance results in the elimination of noise while keeping the most important features, making the subsequent clustering more robust and reliable. Furthermore, dimensionality reduction can be used to address, what is referred to as the curse of dimensionality. In high-dimensional spaces, data becomes sparse, and distance metrics become less meaningful. By reducing dimensions, clustering algorithms like HDBSCAN can perform more effectively, as they rely on distance measurements to identify groups of similar events. Additionally, pattern discovery can be enhanced through dimensionality reduction. Reducing to essential features enables the revealing of underlying patterns that might be obscured in the original high-dimensional space. UMAP can be used to preserve local relationships while making global patterns more apparent, which helps identify meaningful clusters of similar events that can inform rule generation.

Thus, the two-step reduction process used by the technique 800 (e.g., using PCA followed by UMAP) is designed to first capture major linear patterns while preserving 90% of variance, then preserve local data structure in the final, reduced dimensional (e.g., 10-dimensional) representation. The reduction in features prepares the data for effective clustering while maintaining important relationships between events, which is crucial for the overall goal of identifying patterns in event suppression decisions that can be converted into orchestration rules.

At 802, the technique 800 loads (e.g., obtains, accesses, etc.) a dataset of historical events. The dataset of historical events are those events to which the action (e.g., the systemizable action) was applied. The dataset of historical events either explicitly includes indications of whether the systemizable action is applied to each of the records or includes data from which it can be derived whether the systemizable action was applied. To illustrate, each record may include a flag, is suppressed, indicating whether a suppression action was applied to the record. It is noted that the technique 800 operates on the data of a single customer at a time.

At 804, the technique 800 preprocesses the historical events. Preprocessing the historical events may encompass several operations to prepare the data for clustering.

Preprocessing the historical events can include removing 806 columns, extracting 808 features, and splitting 810 the extracted features into features X and target Y.

At 806, certain columns that are known not to contribute meaningfully to clustering are removed from the dataset. For example, columns with low cardinality-such as those containing unique identifiers (e.g., event_storage_id, alert_id) or other attributes with limited variability-are excluded, as they do not provide useful information for identifying clustering patterns.

At 808, the remaining columns (e.g., attributes) may be used as features for the clustering process. These columns represent various characteristics of the events that might be relevant for identifying suppression (e.g., the systemizable action applied to the events) patterns. As such, this step may not perform any additional feature engineering or extraction, but rather uses the existing event attributes as features for the subsequent dimensionality reduction and clustering steps. In other implementations, feature extraction may involve selecting and transforming the remaining columns to better prepare them for machine learning algorithms. Such feature extraction could include using domain expertise to select features known to be relevant for the particular systemizable action, applying statistical tests to identify features correlated with the action, or using feature importance scores from preliminary models.

At 810, the extracted features are split into a feature matrix X and target variable Y, preparing the data for aspects of the process that leverage supervised learning principles. The feature matrix X contains all event attributes that might indicate patterns leading to application of the systemizable action (e.g., the decision to suppress an event), while Y is a binary vector where each element corresponds to an event and indicates whether the systemizable action (e.g., suppression action) was applied (1) or was not applied (0) to that event. More generally, for any systemizable action, Y would be a [0, 1] vector where:
Y[i]=1 indicates the systemizable action was applied to event i
Y[i]=0 indicates the systemizable action was not applied to event i

This splitting of features and target serves multiple purposes: it allows the clustering process to find patterns in the feature space (X) that correlate with systemizable action application (Y); it enables evaluation of cluster quality by measuring how well clusters capture events where the action was applied; and it facilitates the validation of proposed orchestration rules by comparing predicted actions against historical decisions. As further described below, this split can be used in the coverage evaluation of FIG. 8C, where clusters are assessed based on what percentage of their events have Y=1 (had the systemizable action applied), with clusters having more than 80% of events with the action applied being identified as potential bases for orchestration rules.

At 812, the technique sets hyperparameter search spaces based on dataset size. For example, if the dataset is smaller (e.g., contains fewer than a threshold number of records, such as 300,000 records), the hyperparameters may include a UMAP neighbors value of 100 and a min cluster_size range of 50-200. Conversely, for larger datasets (e.g., 300,000 records or more), the UMAP neighbors value is set to 200, and the min cluster size range is expanded to 250-650. In both cases, the search space includes three distance metrics: Chebyshev, Euclidean, and Manhattan.

Briefly, UMAP neighbors determines the size of the neighborhood around each data point that UMAP considers when creating the lower-dimensional representation (i.e., expressing the data using fewer dimensions than the original data while preserving important relationships between data points). A larger number means a larger neighborhood, which can help capture global structure but might blur local details. Min_cluster_size range specifies the minimum number of data points that HDBSCAN considers to form a cluster. A larger range means HDBSCAN will tend to find larger, more general clusters. Distance metrics define how HDBSCAN measures the similarity between data points.

Chebyshev distance looks at the maximum difference in any dimension (e.g., the greatest variation between two points across all features, such as the largest difference in pixel intensity in an image), Euclidean distance is the “ordinary” straight-line distance (e.g., the shortest direct path between two points in a Cartesian plane), and Manhattan distance is the “city block” distance (e.g., the sum of absolute differences between coordinates, such as the total number of horizontal and vertical steps needed to travel on a grid-like map).

At 814, the technique reduces dimensionality through multiple steps. As mentioned, this dimensionality reduction process is crucial for managing computational complexity while preserving important data relationships. Reducing dimensionality may include scaling 816 the features, preserving 818 variances, and further reducing 820 dimensions.

At 816, the features are scaled, such as using StandardScaler, which normalizes the features by subtracting the mean and scaling to unit variance. StandardScaler is a preprocessing technique that standardizes features in a dataset to have zero mean and unit variance. This ensures that all features contribute equally to the analysis and prevents features with larger values from dominating. At 818, the technique 800 applies Principal Component Analysis (PCA) to preserve variance in the data. For example, the PCA can be configured to retain 90% of the data variance. In one illustrative scenario, this configuration reduced N (e.g., N=500) features to M (e.g., M=40) dimensions. At 820, the technique 800 utilizes UMAP to further reduce the dimensionality while preserving the underlying data structure. In the example described above, the PCA output of 40 dimensions was further reduced to 10 dimensions, using a preconfigured number of neighbors (e.g., 100 or 200, depending on the dataset size).

At 822, which is detailed in FIG. 8B, the technique 800 obtains optimal hyperparameters through an iterative process. Referring now to FIG. 8B, at 842, the search space, metrics, and cluster sizes are defined based on the dataset size as previously determined at 812. The search space can be configured to optimize clustering performance for datasets of varying sizes. By systematically defining the search space based on dataset size, the subsequent hyperparameter optimization process can explore configurations that are best suited for the data's scale and structure.

For smaller datasets, such as those containing fewer than 300,000 events (e.g., roughly one third of a million events), the min cluster size range may be narrower, for instance, between 50 and 200, and the number of UMAP neighbors may be set to 100. These settings are appropriate for datasets with fewer data points and less variability. Conversely, for larger datasets, such as those with 300,000 records or more, the min cluster_size range may be expanded to between 250 and 650, and the number of UMAP neighbors may be increased to 200 to account for greater data density and variability.

In addition to defining these size-specific ranges, the search space incorporates a selection of distance metrics, such as Chebyshev, Euclidean, and Manhattan, which are usable in evaluating the “closeness” of data points in the feature space. The choice of distance metric can significantly influence cluster formation by affecting how similarities and differences between data points are calculated. The min cluster size parameter specifies the smallest grouping of data points that can be considered a cluster. This parameter is adjusted to ensure flexibility in capturing meaningful clusters regardless of the dataset's characteristics.

At 844, the next hyperparameter combination is selected using the TPE algorithm. At 846, clustering models are trained using HDBSCAN with the selected hyperparameter combination. In an example, the HDBSCAN may be configured to enable prediction capabilities by setting prediction data=True, allowing the model to predict cluster membership for new, unseen data points. Additionally, the algorithm may be configured with gen min span tree=True to generate a Minimum Spanning Tree (MST) of the mutual reachability graph, which can aid in interpreting the hierarchical relationships and structure of the clusters.

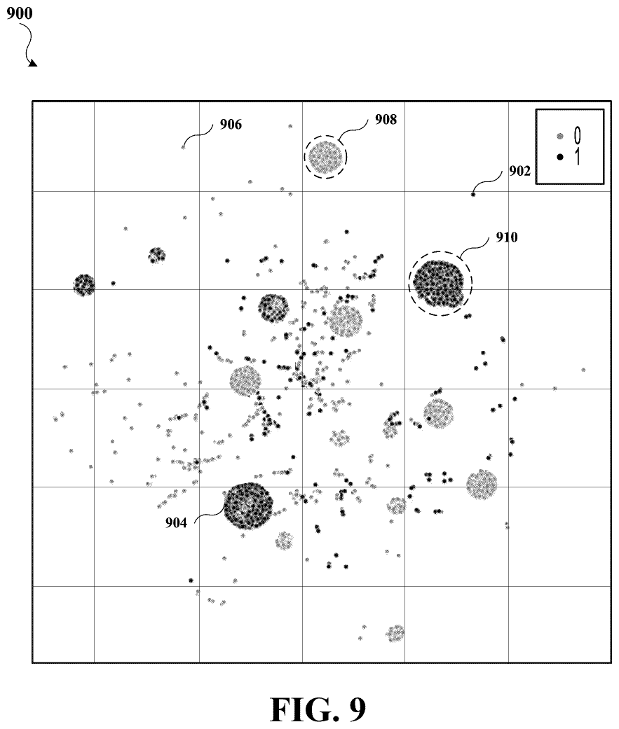

The output of the clustering model training includes a trained HDBSCAN model, which is configured with the selected hyperparameters determined during the optimization process. Additionally, the output includes the cluster assignments for the dataset, identifying which events are grouped into specific clusters and which are classified as noise. This output effectively represents clusters of events, as illustrated in FIG. 9, where distinct clusters and noise points are visually depicted based on their characteristics and clustering results.

At 848, which is detailed in FIG. 8C, model performance is evaluated by calculating, at 862, multiple metrics: coverage, noise percentage, cluster validity, and cluster distribution. As such, at 862 of FIG. 8C, various metrics are calculated for the clustering results. The metrics are stored for later comparison with the metrics of other trained models.

At 864, model coverage is evaluated by determining what percentage of events where the systemizable action was applied are captured within clusters where the systemizable action was predominantly applied. To illustrate, clusters meeting a predominance threshold (e.g., 80% of events had the systemizable action applied) are identified, and then the proportion of all systemizable action-applied events found in these clusters is calculated. For example, if a coverage value (e.g., 70%) of all suppressed events are found in clusters meeting the predominance threshold, the coverage would be that value. Higher coverage indicates the model successfully identifies patterns in how the systemizable action was applied.

At 866, a noise percentage is measured by calculating the proportion of events classified as noise (e.g., labeled as −1) by HDBSCAN. In an example, a noise threshold (e.g., 50%) may be enforced: if the noise percentage exceeds this threshold, the model is considered invalid. This ensures the clustering captures meaningful patterns while allowing some events to be classified as noise when they don't fit clear patterns.

At 868, cluster validity is checked using HDBSCAN's relative validity score. This score, which is specific to HDBSCAN clustering, assesses the quality of the hierarchical cluster structure by evaluating both the density within clusters and the separation between clusters.

Higher validity scores indicate more distinct and well-formed clusters in the hierarchy of the clustering solution. At 870, the distribution of clusters is analyzed by examining characteristics relevant to orchestration rule generation: the number of clusters where the systemizable action was predominantly applied, the size distribution of these clusters, and identification of the largest such cluster.

Referring again to FIG. 8B, at 850, the technique 800 checks if more hyperparameter combinations should be tested. If so, then the technique 800 proceeds back to 844 to select the next combination of hyperparameters; otherwise, the technique 800 proceeds to 824 of FIG. 8A.

At 824 of FIG. 8A, the best model is selected based on a comparison of their respective calculated metrics. Specifically, among all the valid models and models that maintain a noise percentage of less than 50%, the model that achieves the highest coverage of events where the systemizable action was applied is selected.

At 826, the technique 800 generates proposed orchestration rules based on the clustering results obtained by the selected best model. For each cluster that meets predefined metrics (e.g., clusters where more than 80% of events had the systemizable action applied), the technique 800 extracts (e.g., derives) attributes and values (e.g., characteristics) that characterize the cluster. Using these attributes, the technique 800 defines conditions and actions for proposed orchestration rules. For example, if a cluster includes events with the attribute “source=database” and “severity=high” that were frequently suppressed, the technique may generate a proposed orchestration rule that, if accepted, would automatically suppress such future events. This extraction of cluster characteristics enables the generation of human-readable and actionable orchestration rules that capture the patterns identified in the historical application of systemizable actions.

FIG. 9 illustrates a two-dimensional visualization 900 of a clustering output generated by a clustering model. In the visualization 900, each dot (e.g., dots 902, 904, or 906) represents an event in a historical dataset. Events are categorized based on their patterns and clustering results. Dots in a first pattern, such as dot 902, correspond to events where the systemizable action was applied (e.g., the event is suppressed). In contrast, dots in a second pattern, such as dot 906, represent events where the systemizable action was not applied (e.g., the event is not suppressed). The proximity of dots, such as those grouped within clusters 908 and 910, reflects events with similar custom-defined fields, indicating meaningful relationships between these data points.

Some events, which are not part of any cluster, are identified as outliers. These unclustered points typically represent events that do not fit into the identified patterns of the dataset. Notably, the visualization 900 highlights several clusters (e.g., the cluster 910) that represent groups of similar events, all of which led to event suppression. Such clusters are used for extracting conditions for generating proposed orchestration rules. By analyzing these clusters, insights were derived to inform the creation of proposed orchestration rules to optimize event handling.

FIG. 10 is an example of a user interface 1000 for displaying proposed orchestration rules. The user interface 1000 can be generated by the orchestration rule presentation tool 708 of FIG. 7. The user interface 1000 displays event details, such as the event title, status, urgency, opening date, and assignee. An indicator 1002 on the “RECOMMENDATIONS” tab shows that two proposed orchestration rules are associated with this event. Said another way, the displayed event meets the characteristics associated with the proposed orchestration rule. These proposed orchestration rules were generated by orchestration rule generation software, such as the orchestration rule generation software 700 of FIG. 7, using the technique 800 of FIGS. 8A-8C.

A first proposed orchestration rule 1004 includes a systemizable action 1008 to “SET SEVERITY TO: CRITICAL” and conditions 1010 (i.e., event characteristics) specifying when this action should be applied. A second proposed rule 1006 includes a systemizable action to “SUPPRESS INCIDENT AND NOTIFICATIONS” and conditions (e.g., characteristics) specifying this action should be applied.

Each proposed orchestration rule is associated with a checkbox (e.g., checkboxes 1012 and 1014) that allows the user to select rules for incorporation into the orchestration software 504 of FIG. 5. When a checkbox is selected, the corresponding rule is integrated, enabling automatic application of the systemizable action to any incoming event matching the specified conditions. For example, if an incoming event satisfies the three conditions in the first proposed orchestration rule 1004, its severity would automatically be set to CRITICAL. Similarly, if an event matches the two conditions in the second proposed rule 1006, the incident and its associated notifications that would otherwise be generated therefrom would automatically be suppressed.

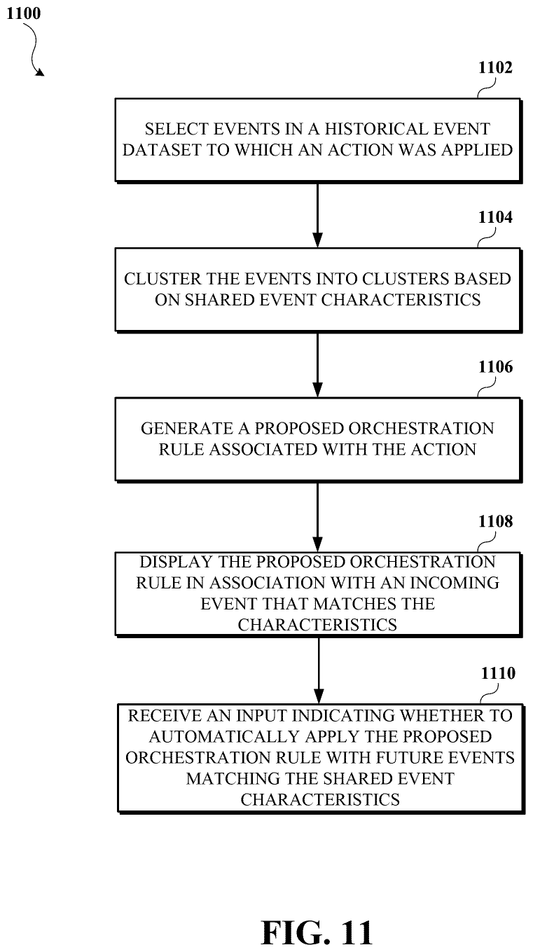

FIG. 11 illustrates an example technique 1100 for generating and applying orchestration rules based on historical event data. This technique 1100 can be implemented using systems, software, and methods, such as those described in connection with FIGS. 1-10. The technique 1100 is operable as part of an orchestration rule generation system and can be performed by executing machine-readable instructions, routines, or programs on computing devices.

For simplicity of explanation, the technique 1100 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1102, events in a historical event dataset to which an action (e.g., a systemizable action) was applied are selected. The action may be a manually applied action. The action may be a manually applied action. The historical event dataset may include events with shared characteristics and specific attributes that may make them eligible for clustering and orchestration rule generation. At 1104, the selected events are clustered into groups based on shared event characteristics, such as common fields or attributes and values. Clustering may be performed as described with respect to FIGS. 8A-8C. As such, clustering may include defining a search space for hyperparameters, such as metrics and minimum cluster size, performing clustering using various hyperparameter combinations, evaluating clustering quality based on loss functions, and selecting the best set of hyperparameters. Additionally, the evaluation of clustering quality can involve assessing the percentage of events in each cluster to which the action was applied and measuring the percentage of events classified as noise.

At 1106, a proposed orchestration rule is generated based on one of the clusters and is associated with the action. The proposed orchestration rule specifies conditions for applying the action to incoming events that match the shared characteristics of events within the cluster. For example, the conditions may include event attributes, such as priority levels or suppression criteria, identified as relevant from the cluster data. At 1108, the proposed orchestration rule is displayed in association with an incoming event that matches the shared characteristics identified during clustering. The proposed orchestration rule may be presented in a user interface that allows for review and modification. The user interface provides an input mechanism to receive user confirmation regarding whether the proposed rule should be automatically applied to future events with matching characteristics. For example, the user may accept the proposed rule as part of active orchestration rules or reject it based on specific criteria.

At 1110, an input is received indicating whether to automatically apply the proposed orchestration rule to future events matching the characteristics. The input is used to enable or disable the proposed orchestration rule for automation. In some implementations, conflicting orchestration rules may also be identified, and users may receive the option to disable such conflicting rules to ensure consistent execution of the proposed rule.

Some implementations are described below as numbered examples (Example 1, 2, 3, etc.). These examples are provided as examples only and do not limit the other implementations disclosed herein.

Example 1 is a method that includes selecting events in a historical event dataset to which an action was applied; clustering the events into clusters based on shared event characteristics; generating a proposed orchestration rule associated with the action, wherein the proposed orchestration rule specifies conditions for applying the action to events that match the shared event characteristics of events within one of the clusters; displaying the proposed orchestration rule in association with an incoming event that matches the shared event characteristics; and receiving an input indicating whether to automatically apply the proposed orchestration rule with future events matching the shared event characteristics.

Example 2 is the method of Example 1 that includes clustering the events into the clusters based on the shared event characteristics by defining a search space for a plurality of hyperparameters for the clustering; performing the clustering using a plurality of different sets of hyperparameters from the search space; evaluating the clustering for each of the plurality of different sets of the hyperparameters based on a loss function; and selecting a set of the hyperparameters that minimizes the loss function.

Example 3 is the method of Example 2 that includes the search space for the plurality of hyperparameters including a metric and a minimum cluster size.

Example 4 is the method of Example 3 that includes evaluating the clustering based on a percentage of events to which the action was applied and a percentage of events classified as noise.

Example 5 is the method of Example 1 that includes applying the proposed orchestration rule to subsequent incoming events that match the shared event characteristics.

Example 6 is the method of Example 1 that includes the action being associated with event prioritization or suppression.

Example 7 is the method of Example 1 that includes displaying the proposed orchestration rule by displaying the rule in a user interface associated with the incoming event, wherein the input indicating whether to automatically apply the proposed orchestration rule is received via the user interface.

Example 8 is the method of Example 1 that includes the input indicating whether to automatically apply the proposed orchestration rule comprising user confirmation to accept the rule as part of active orchestration rules.

Example 9 is the method of Example 1 that includes identifying, with respect to events having the shared event characteristics, a conflicting orchestration rule to the proposed orchestration rule and disabling the conflicting orchestration rule.

Example 10 is a system that includes one or more memories and one or more processors, the one or more processors configured to execute instructions stored in the one or more memories to select events in a historical event dataset to which an action was applied; cluster the events into clusters based on shared event characteristics; generate a proposed orchestration rule associated with the action, wherein the proposed orchestration rule specifies conditions for applying the action to events that match the shared event characteristics of events within one of the clusters; display the proposed orchestration rule in association with an incoming event that matches the shared event characteristics; and receive an input indicating whether to automatically apply the proposed orchestration rule with future events matching the shared event characteristics.

Example 11 is the system of Example 10 that includes clustering the events into the clusters based on the shared event characteristics by defining a search space for a plurality of hyperparameters for the clustering; performing the clustering using a plurality of different sets of hyperparameters from the search space; evaluating the clustering for each of the plurality of different sets of the hyperparameters based on a loss function; and selecting a set of the hyperparameters that minimizes the loss function.

Example 12 is the system of Example 11 that includes the search space for the plurality of hyperparameters including a metric and a minimum cluster size.

Example 13 is the system of Example 12 that includes evaluating the clustering based on a percentage of events to which the action was applied and a percentage of events classified as noise.

Example 14 is the system of Example 10 that includes the one or more processors further configured to execute instructions stored in the one or more memories to apply the proposed orchestration rule to subsequent incoming events that match the shared event characteristics.

Example 15 is the system of Example 10 that includes the action being associated with event prioritization or suppression.

Example 16 is the system of Example 10 that includes displaying the proposed orchestration rule by displaying the rule in a user interface associated with the incoming event, wherein the input indicating whether to automatically apply the proposed orchestration rule is received via the user interface.

Example 17 is the system of Example 10 that includes the input indicating whether to automatically apply the proposed orchestration rule comprising user confirmation to accept the rule as part of active orchestration rules.

Example 18 is the system of Example 10 that includes the one or more processors further configured to execute instructions stored in the one or more memories to identify, with respect to events having the shared event characteristics, a conflicting orchestration rule to the proposed orchestration rule and disable the conflicting orchestration rule.

Example 19 is one or more non-transitory computer readable media storing instructions operable to cause one or more processors to perform operations comprising selecting events in a historical event dataset to which an action was applied; clustering the events into clusters based on shared event characteristics; generating a proposed orchestration rule associated with the action, wherein the proposed orchestration rule specifies conditions for applying the action to events that match the shared event characteristics of events within one of the clusters; displaying the proposed orchestration rule in association with an incoming event that matches the shared event characteristics; and receiving an input indicating whether to automatically apply the proposed orchestration rule with future events matching the shared event characteristics.

Example 20 is the one or more non-transitory computer readable media of Example 19 that includes clustering the events into the clusters based on the shared event characteristics by defining a search space for a plurality of hyperparameters for the clustering; performing the clustering using a plurality of different sets of hyperparameters from the search space; evaluating the clustering for each of the plurality of different sets of the hyperparameters based on a loss function; and selecting a set of the hyperparameters that minimizes the loss function.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C #, and/or the like. A software may be compiled into executable programs or written in interpreted programming languages. Software may be callable from other software or from themselves. Software described herein refer to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A method, comprising:
selecting events in a historical event dataset of an event management bus to which an action was manually applied by one or more responders;
defining a search space for a plurality of hyperparameters for clustering the events, wherein the search space is based on a size of the historical event dataset;
clustering the events into clusters based on shared event characteristics by performing the clustering using a plurality of different sets of hyperparameters from the search space;
evaluating the clustering for each of the plurality of different sets of the hyperparameters based on a loss function;
selecting a set of the hyperparameters that minimizes the loss function;
generating a proposed orchestration rule associated with the action by extracting, from one of the clusters, attributes and values that characterize the one of the clusters and defining, based on the extracted attributes and values, conditions and the action for the proposed orchestration rule, wherein the proposed orchestration rule is for automating processing of events of the event management bus and specifies the conditions for automatically applying the action to events that match the shared event characteristics of events within one of the clusters;
displaying the proposed orchestration rule in association with an incoming event of the event management bus that matches the shared event characteristics; and
receiving an input indicating whether to accept the proposed orchestration rule for automatically applying the action to future events matching the shared event characteristics.

2. (canceled)

3. The method of claim 1, wherein the search space for the plurality of hyperparameters includes a metric and a minimum cluster size.

4. The method of claim 3, wherein evaluating the clustering is based on a percentage of events to which the action was applied and a percentage of events classified as noise.

5. The method of claim 1, further comprising:
applying the proposed orchestration rule to subsequent incoming events that match the shared event characteristics.

6. The method of claim 1, wherein the action is associated with event prioritization or suppression.

7. The method of claim 1, wherein displaying the proposed orchestration rule further comprises:
displaying the rule in a user interface associated with the incoming event, wherein the input indicating whether to automatically apply the proposed orchestration rule is received via the user interface.

8. The method of claim 1, wherein the input indicating whether to automatically apply the proposed orchestration rule comprises user confirmation to accept the rule as part of active orchestration rules.

9. The method of claim 1, further comprising:
identifying, with respect to events the shared event characteristics, a conflicting orchestration rule to the proposed orchestration rule; and
disabling the conflicting orchestration rule.

10. A system, comprising:
one or more memories; and
one or more processors, the one or more processors configured to execute instructions stored in the one or more memories to:
select events in a historical event dataset of an event management bus to which an action was manually applied by one or more responders;
define a search space for a plurality of hyperparameters for clustering the events, wherein the search space is based on a size of the historical event dataset;
cluster the events into clusters based on shared event characteristics by performing the clustering using a plurality of different sets of hyperparameters from the search space;
evaluate the clustering for each of the plurality of different sets of the hyperparameters based on a loss function;
select a set of the hyperparameters that minimizes the loss function;
generate a proposed orchestration rule associated with the action by extracting, from one of the clusters, attributes and values that characterize the one of the clusters and defining, based on the extracted attributes and values, conditions and the action for the proposed orchestration rule, wherein the proposed orchestration rule is for automating processing of events of the event management bus and specifies the conditions for automatically applying the action to events that match the shared event characteristics of events within one of the clusters;
display the proposed orchestration rule in association with an incoming event of the event management bus that matches the shared event characteristics; and
receive an input indicating whether to accept the proposed orchestration rule for automatically applying the action to future events matching the shared event characteristics.

11. (canceled)

12. The system of claim 10, wherein the search space for the plurality of hyperparameters includes a metric and a minimum cluster size.

13. The system of claim 12, wherein evaluating the clustering is based on a percentage of events to which the action was applied and a percentage of events classified as noise.

14. The system of claim 10, wherein the one or more processors further configured to execute instructions stored in the one or more memories to:
apply the proposed orchestration rule to subsequent incoming events that match the shared event characteristics.

15. The system of claim 10, wherein the action is associated with event prioritization or suppression.

16. The system of claim 10, wherein to display the proposed orchestration rule further comprises to:
display the rule in a user interface associated with the incoming event, wherein the input indicating whether to automatically apply the proposed orchestration rule is received via the user interface.

17. The system of claim 10, wherein the input indicating whether to automatically apply the proposed orchestration rule comprises user confirmation to accept the rule as part of active orchestration rules.

18. The system of claim 10, wherein the one or more processors further configured to execute instructions stored in the one or more memories to:
identify, with respect to events the shared event characteristics, a conflicting orchestration rule to the proposed orchestration rule; and
disable the conflicting orchestration rule.

19. One or more non-transitory computer readable media storing instructions operable to cause one or more processors to perform operations comprising:
selecting events in a historical event dataset of an event management bus to which an action was manually applied by one or more responders;
defining a search space for a plurality of hyperparameters for clustering the events, wherein the search space is based on a size of the historical event dataset;
clustering the events into clusters based on shared event characteristics by performing the clustering using a plurality of different sets of hyperparameters from the search space;
evaluating the clustering for each of the plurality of different sets of the hyperparameters based on a loss function;
selecting a set of the hyperparameters that minimizes the loss function;
generating a proposed orchestration rule associated with the action by extracting, from one of the clusters, attributes and values that characterize the one of the clusters and defining, based on the extracted attributes and values, conditions and the action for the proposed orchestration rule, wherein the proposed orchestration rule is for automating processing of events of the event management bus and specifies the conditions for automatically applying the action to events that match the shared event characteristics of events within one of the clusters;
displaying the proposed orchestration rule in association with an incoming event of the event management bus that matches the shared event characteristics; and
receiving an input indicating whether to accept the proposed orchestration rule for automatically applying the action to future events matching the shared event characteristics.

20. (canceled)

21. The method of claim 1, wherein clustering the events into the clusters further comprises:
reducing dimensionality of characteristics of the events through a two-step reduction process comprising:
applying principal component analysis to preserve a percentage of variance in the characteristics; and
applying uniform manifold approximation and projection to further reduce the characteristics to a lower-dimensional representation while preserving local data structure.

22. The method of claim 1, wherein generating the proposed orchestration rule comprises:
generating the proposed orchestration rule for each cluster in which a percentage of events to which the action was manually applied meets a predominance threshold.

23. The method of claim 1, wherein selecting the set of the hyperparameters that minimizes the loss function comprises:
determining, for each of the plurality of different sets of the hyperparameters, a coverage metric representing a percentage of events to which the action was applied that are captured within clusters meeting a predominance threshold; and
selecting the set of the hyperparameters based on a highest coverage metric among sets of the hyperparameters that maintain a noise percentage below a noise threshold.
